(19) United States
(12) Patent Application Publication
(10) Pub. No.: US 2012/0317837 A1
(43) Pub. Date: Dec. 20, 2012

(54) SELF SEALING VULCANIZED SYSTEM FOR WATERPROOF COUPLING OF UPPERS TO OUTSOLES

(75) Inventors: Xiao Dong Liu, Zhuhai City (CN); Yi Jiang Wei, Zhuhai City (CN); Peng Cheng Xia, Zhuhai City (CN)

(73) Assignee: COLUMBIA SPORTSWEAR NORTH AMERICA, INC., Portland, OR (US)

(21) Appl. No.: 13/526,426

(22) Filed: Jun. 18, 2012

Related U.S. Application Data
(60) Provisional application No. 61/498,351, filed on Jun. 17, 2011.

(51) Int. Cl. A43B 1/10; B32B 37/12; B32B 37/26; B32B 37/02; D05B 93/00; A43B 23/00

(52) U.S. Cl. 36/87; 112/402; 36/57; 156/307.1; 156/93; 156/306.9; 156/305

(57) ABSTRACT

Embodiments herein relate to the field of waterproofing, and, more specifically, to waterproof footwear and methods of waterproofing a stitch line in footwear. In various embodiments, methods are provided for waterproofing a seam in an article of footwear by positioning an uncured rubber tape between the layers to be stitched, stitching the seam through the uncured rubber tape, and at least partially curing the rubber tape.

### CROSS REFERENCE TO RELATED APPLICATIONS

The present application claims priority to U.S. Provisional Patent Application No. 61/498,351, filed Jun. 17, 2011, entitled “Self Sealing Vulcanized System for Waterproofing Uppers to Shell Outsoles,” the entire disclosure of which is hereby incorporated by reference in its entirety.

### TECHNICAL FIELD

Embodiments herein relate to the field of waterproofing, and, more specifically, to waterproof footwear and methods of waterproofing a stitch line in footwear.

### BACKGROUND

Many types of footwear and other outerwear have seams that must be sealed for waterproofing, and many types of self-sealing seam construction techniques have been proposed. One such approach is to apply a cover strip or tape of various materials over the seam after it has been formed. However, such tapes can be difficult to place properly and can leak. In other instances, multiple layers of sealing cement may be applied over the seam in a process referred to as “gunking.” Though effective, the gunking procedure is labor-intensive and time-consuming. Additionally, gunking may result in hardening of the upper areas and contamination of the cement with dirt and/or debris once it has been applied to the footwear.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates a method of coupling rubber tape to a footwear upper, in accordance with various embodiments;

FIG. 2 illustrates a footwear upper and outsole shell ready for assembly, in accordance with various embodiments;

FIG. 3 illustrates an assembled boot in which the seam has been sealed, in accordance with various embodiments;

FIG. 4 is a schematic diagram illustrating a method of forming a waterproof seam in an article of footwear, in accordance with various embodiments;

FIG. 5 is a schematic diagram illustrating a method of forming a waterproof seam in an article of footwear, which method corresponds to the method illustrated in FIG. 4, plus one additional step, in accordance with various embodiments;

FIG. 6 is a schematic diagram illustrating a method of forming a waterproof seam in an article of footwear, which method corresponds to the method illustrated in FIG. 5, plus one additional step, in accordance with various embodiments; and

FIG. 7 is a schematic diagram illustrating a method of forming a waterproof seam in an article of footwear, which method corresponds to the method illustrated in FIG. 6, plus one additional step, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form at least one of A, B, and C″ means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In various embodiments, methods, apparatuses, and systems for waterproofing a stitch line in footwear are provided. Some types of footwear, such as boots and shoes, may be constructed by securing an upper portion to a shell outsole. In various embodiments, the seam between the upper and the shell outsole may be stitched, creating a secure junction, but also creating a stitch line for which waterproofing may be desired. In many applications, this seam line may be waterproofed by applying successive layers of adhesives in a process referred to as gunking. Though effective, gunking is time consuming and may cause manufacturing bottlenecks and/or hardening of portions of the uppers.

Disclosed herein are methods for waterproofing a stitch line or other seam in an article of footwear that may eliminate or reduce the number of gunking layers that are needed to achieve a waterproof seam. In various embodiments, a layer of tape that includes uncured natural or synthetic rubber (or a combination thereof) may be included between the outsole (such as a shell outsole) and the upper. In some embodiments, the seam may then be stitched or otherwise fixed in place by fastening elements, forming a seam with the tape layer positioned between the outsole and the upper. In some embodiments, the resulting seam (or the entire article of footwear) may be heated to at least partially cure the rubber and/or to allow the rubber tape to at least partially flow into empty spaces, thus forming a waterproof, water-resistant, and/or water-tight seam. In various embodiments, the disclosed methods may create a seal that meets or exceeds the waterproof testing requirements typically applied to footwear manufactured using a standard gunking technique. Additionally, in various embodiments, the methods may be used to waterproof any seam, including those not normally subjected to the gunking process. Furthermore, although the examples illustrated herein depict a leather upper coupled to a rubber shell outsole, one of skill in the art will appreciate that various materials may be joined in accordance with the embodiments described herein. For example, the methods may be used to waterproof a seam between layers of leather, plastic, rubber, natural fabric, synthetic fabric, and/or other natural or synthetic materials.

In various embodiments, the uncured rubber tape may include any rubber or synthetic rubber compound or composite that may be cured with the application of heat or at room temperature. For instance, in various embodiments, the uncured rubber compound may include synthetic rubber, natural rubber, other polymers, or a combination thereof, as well as additional fillers, activators, accelerators, sulfur compounds, anti-oxygen compounds, etc. Specific, non-limiting examples of rubber compounds that may be used include isoprene rubber (I), butyl rubber (IIR), neoprene rubber (CR), butadiene rubber (BR), styrene-butadiene rubber (SBR), solution styrene-butadiene rubber (SSBR), and nitrile butadiene rubber (NBR). Without being bound by theory, applying the rubber tape to the footwear in the uncured state may allow the rubber to at least partially flow into small spaces between the footwear layers and/or into the holes created in the footwear layers by the stitching and/or other fastening elements. In some embodiments, the rubber may then be allowed to cure naturally, or curing may be accelerated by the application of heat.

In some examples, the uncured rubber tape may be about 10-30 mm wide, for example, about 12, 14, 16, 18, 20, 22, 24, 26, or 28 mm wide. In some examples, the uncured rubber tape may have a thickness of from about 0.5 mm to about 1.5 mm, for example, about 0.6 mm, about 0.8 mm, about 1.0 mm, or about 1.2 mm thick. In specific embodiments, the rubber tape may also include one or more polymers adapted to add flexibility, flowability, stretch, resilience, strength, or another desired property. In particular embodiments, the uncured rubber tape may be a single, uniform layer of uncured rubber (with or without additional polymers) with no additional backing layer or other layers.

In various embodiments, the uncured rubber tape may be coupled to the footwear upper and/or shell outsole using adhesive or cement. In specific, non-limiting examples, the cement may include polyurethane cement, hotmelt cement, CR cement, CR-grafted adhesive, latex adhesive, natural rubber paste, synthetic rubber paste, or a combination thereof. In one specific, non-limiting embodiment, a strip of cement may be applied to the inside edge of an upper and/or one side of the uncured rubber tape, and the uncured rubber tape may be applied to the inside edge of the leather upper. In some embodiments, a hammer, roller, or other device may be used to flatten or smooth the tape into position once it has been applied to the upper. In various embodiments, a corresponding strip of cement may be applied to the outside edge of the shell outsole in preparation for receiving the uncured rubber tape when coupled to the upper.

In another specific embodiment, a strip of cement may be applied to the outside edge of a shell outsole and/or one side of the uncured rubber tape, and the uncured rubber tape may be applied to the outside edge of the shell outsole. In some embodiments, a hammer, roller, or other device may be used to flatten or smooth the tape into position once it has been applied to the shell outsole. In various embodiments, a corresponding strip of cement may be applied to the inside edge of the upper in preparation for receiving the uncured rubber tape when coupled to the shell outsole.

In some embodiments, the strip of cement or other adhesive may be the same width as the uncured rubber tape, whereas in other embodiments, the strip of cement may be slightly wider than the width of the uncured rubber tape. In one specific, non-limiting embodiment, the rubber tape may have a width of about 20 mm and the strip of cement may have a width of about 25 mm. In various embodiments, the cement strip may be applied using a brush, a roller, or any other known applicator.

In various embodiments, once the upper and shell outsole are coupled with the uncured rubber tape positioned between the two layers, the layers may be stitched or otherwise coupled together, for instance using a plurality of fastening elements such as grommets or tacks. In one specific, non-limiting example, the upper may be stitched to the shell outsole, for instance using a conventional sewing machine known to those of skill in the art. In various embodiments, stitching the layers together may compress the uncured rubber tape, causing it to flow into and fill any open spaces between the layers. In particular embodiments, the compression produced by the stitching also may apply sufficient force to cause the uncured rubber tape to flow at least partially into the holes created by the needle and thread. In various embodiments, this process may result in a waterproof, watertight, and/or water-resistant seam.

In various embodiments, following stitching, heat may be applied to the rubber tape to accelerate curing of the rubber and/or to assist the tape to flow into empty spaces and create a waterproof seal. Without being bound by theory, curing of the rubber may allow the rubber tape to be fixed in position, and may prevent further flowing of the tape. In some embodiments, the tape may be heated to about 50° C., for example, about 65° C., about 70° C., about 75° C., about 80° C., about 85° C., about 90° C., about 100° C., or an even higher temperature. In some embodiments, this may be accomplished by applying heat directly to the seam, whereas in other embodiments, the footwear may be heated in an oven, under a heat lamp, or by any other radiant heat source. In one specific, non-limiting example, the footwear may be passed through a heating tunnel for about 5-15 minutes at a temperature for about 80-85° C., which may result in a footwear temperature of about 78° C. In some embodiments, following heating, the seam may be further compressed using a hammer, roller, or other flattening device.

In various embodiments, one or more gunking adhesive layers may be applied to other parts of the footwear where additional waterproofing is desired, such as the heel and/or vamp regions of the upper. In various embodiments, these regions may be gunked prior to or after the seam has been taped, stitched, and/or heated. In other embodiments, the taped, sealed seam may be further waterproofed by applying one or more layers of gunking adhesive using conventional methods. For instance, in some embodiments, a layer of gunking adhesive may be applied to the interior surface of the taped, sealed seam either before or after the footwear is heated. In particular embodiments, one or more subsequent layers of gunking adhesive may be added if further waterproofing is desired. However, one of skill in the art will recognize that in various embodiments, such additional gunking steps may not be required in order to meet the desired waterproofing standard.

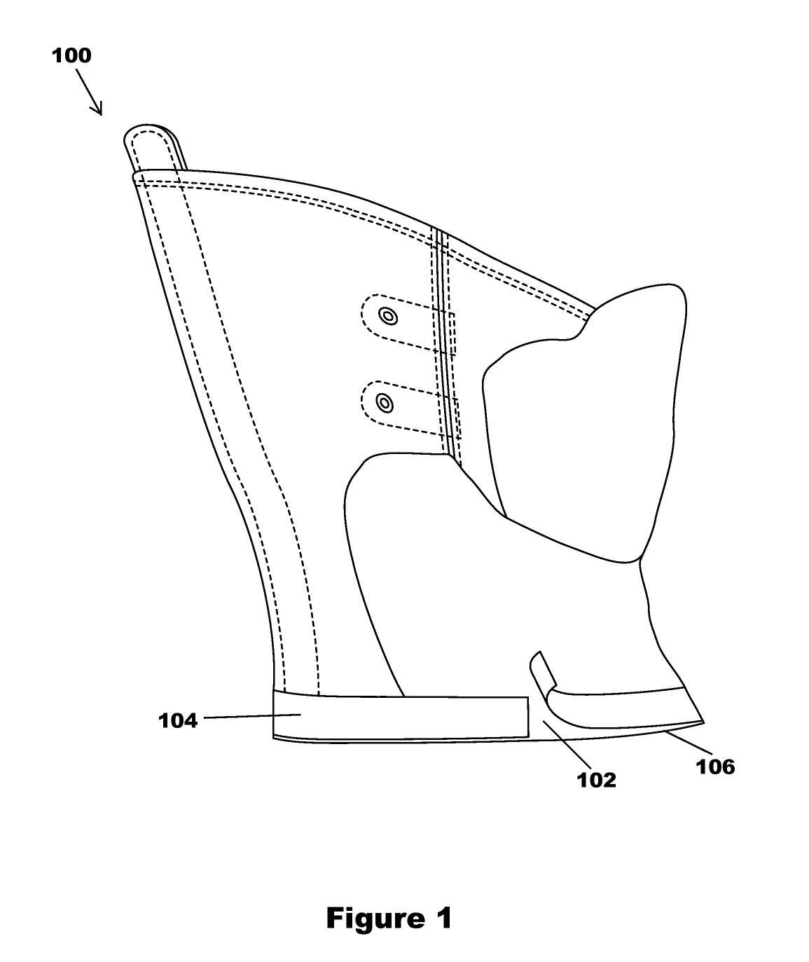

FIG. 1 illustrates a method of coupling rubber tape to a footwear upper, in accordance with various embodiments. In the illustrated embodiment, the footwear upper 100 has been turned inside out so that the inner surface may be accessed. In some embodiments, one or more layers of gunking adhesive (not shown) may be applied to the inside vamp and heel regions of the leather upper portion of the footwear upper at this stage. In various embodiments, this gunking adhesive may include a CR-based adhesive, polyurethane cement, hotmelt adhesive, CR cement, CR-grafted adhesive, latex adhesive, natural rubber paste, synthetic rubber paste, or a mixture thereof. As shown in FIG. 1, a strip of cement 102 may then be applied to the inner, bottom edge of footwear upper 100, for example when footwear upper 100 is configured to overlap the shell outsole (not shown) on the outside surface of the outsole. In other embodiments, wherein footwear upper 100 is configured to overlap the shell outsole on the inside surface, the cement would be applied to the outer surface of footwear upper 100, instead.

In the illustrated example, the width of cement strip 102 is about 20-25 mm, however, one of skill in the art will appreciate that cement strip 102 may be of any width sufficient to couple uncured rubber tape 104 to footwear upper 100. In particular embodiments, the cement may comprise GL-033N/NW cement, although one of skill in the art will appreciate that many different suitable cements may be substituted. In some embodiments, a corresponding strip of primer, such as NP11 primer, also may be applied to uncured rubber tape 104. Although the method as disclosed herein describes applying cement to footwear upper 100 and primer to uncured rubber tape 104, one of skill in the art will appreciate that in other embodiments, primer may be applied to footwear upper 100 and cement may be applied to uncured rubber tape 104. In still other embodiments, cement may be applied to both components.

In various embodiments, a narrow strip of uncured synthetic and/or natural rubber may be cut from a larger piece to create uncured rubber tape 104. In some embodiments, cement adhesive may be applied directly to uncured rubber tape 104 and/or to the portion of the footwear to which uncured rubber tape 104 will be affixed, and uncured rubber tape 104 may then be attached to the lower inside edge 106 of footwear upper 100 as illustrated in FIG. 1. In some embodiments, a hammer or roller may be used to flatten uncured rubber tape 104, and footwear upper 100 may be turned right-side-out.

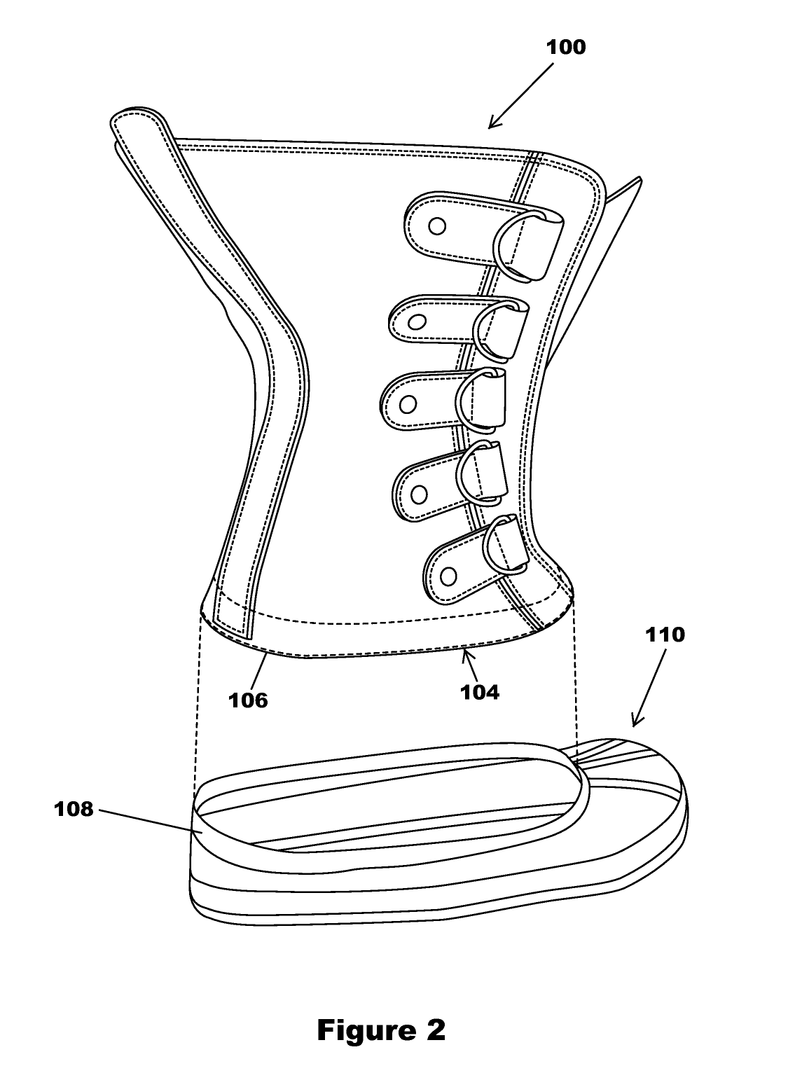

FIG. 2 illustrates a footwear upper and outsole shell ready for assembly, in accordance with various embodiments. As illustrated, in various embodiments, footwear upper 100 may be turned right side out and uncured rubber tape 104 is positioned to rest between lower inside edge 106 of footwear upper 100 and upper outside edge 108 of outsole shell 110 when the footwear is assembled.

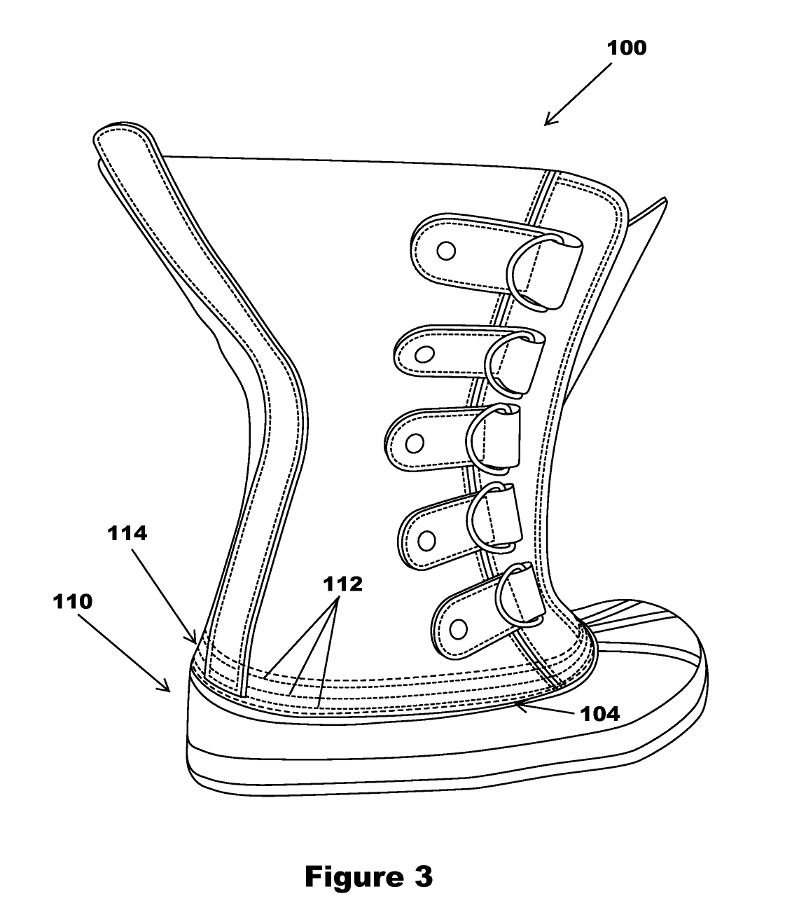

FIG. 3 illustrates an assembled boot in which the seam has been sealed, in accordance with various embodiments. In various embodiments, the taped footwear upper 100 may be fastened to outsole shell 110 using conventional methods. As illustrated, in some embodiments, one or more rows of stitching 112 may be used, for example one, two, or three rows of stitching. Once stitched, seam 114 may be set by curing rubber tape 104 to waterproof seam 114, in accordance with various embodiments. In some embodiments, the taped, stitched footwear may be heated, for example in a heating tunnel, at a temperature of about 80-85° C. In one specific, non-limiting example, the heated footwear may reach a temperature of approximately 78° C. after heating for about 8 minutes. In some embodiments, a hammer or other tool may be used to flatten and secure seam 114 following heating.

In some embodiments, the rubber tape used in various embodiments may conform to a desired set of properties, such as hardness, thickness, density, tensile strength, and the like. One specific, non-limiting set of desired properties is illustrated in Table 1, below. One of skill in the art will appreciate that other properties may be desirable for other applications.

TABLE 1

| | | |
|---|---|---|
| Property | Test Method | Hardness |

Before Curing

| | | |
|---|---|---|
| Hardness (Ask C) | SATRA TM205 | 1.0-1.2 MM |
| | ASTM D-2240 | |
| Thickness | / | T2: 6-9M; T90: Ignored |
| Rheometer Test | 130 | T2: 6-9M; T90: Ignored |

After Curing

| | | |
|---|---|---|
| Hardness (Shore A) | SATRA TM205 | 1.30-1.40 |
| | ASTM D-2240 | |
| Density (g/cm³) | SATRA TM134 | Min 30 |
| | ASTM D-297 | |
| Tensile strength | SATRA TM137 | Min 450 |
| (kg/cm²) test | ASTM D-412 | |
| Elongation at | SATRA TM137 | 50,000 no damage |
| break (%) | ASTM D-412 | |
| Ross flex (no more | SATRA TM60 | 15,000 pass |
| than 2 mm cut, after | ASTM D-1052 | |
| number of flexes | | |
| at −20° C.) | | |
| Water-proof test | SATRA TM 77 | |
| (Cycles) | | |

In some embodiments, different formulations of the rubber tape may be selected for different purposes. Table 2 illustrates two specific, non-limiting examples of rubber tape formulations that may be used.

TABLE 2

| Raw Materials | Formula 1 | | Formula 2 | |
|---|---|---|---|---|
| POLYMERS | | | 70 | (ADSL) |
| STR 3L | 100 | (3L) | 30 | (IR 3S) |
| ZnO | 4 | | 4 | |
| S-80 (sulfur-based rubber | 2.3 | | 0.4 | |
| vulcanizing agent) | | | | |
| MBT-80 (e.g., | 0.3 | (MBT-80) | 0.7 | (F) |
| agglutination of 2- | | | | |
| mercapto benzothiazole) | | | | |
| Rubber Accelerator DM-80 | 2.1 | | 0.6 | |
| TMTM-80 (e.g., | 0.05 | | 0.1 | |
| tetramethyl thiuram | | | | |
| monosulfide) | | | | |
| Rubber antioxidant | 0.8 (SP; styrenated | | 0.8 (BHT; butylated | |
| | phenol) | | hydroxytoluene) | |
| Process aid | 1 | (CH236) | 5 | (SK-120) |

| | | | |
|---|---|---|---|
| Microcrystalline wax | 0.5 | (P-10) | 0 |

| Silica ZC-185 | 10 | 0 |
|---|---|---|
| (e.g., IM VN 3 GR) | | |
| 1956 | 0.5 | 0 |
| PEG 4000 | 1 | 0 |
| ST/AC | 1 | 0.8 |
| CaCO₃ | 60 | 80 |

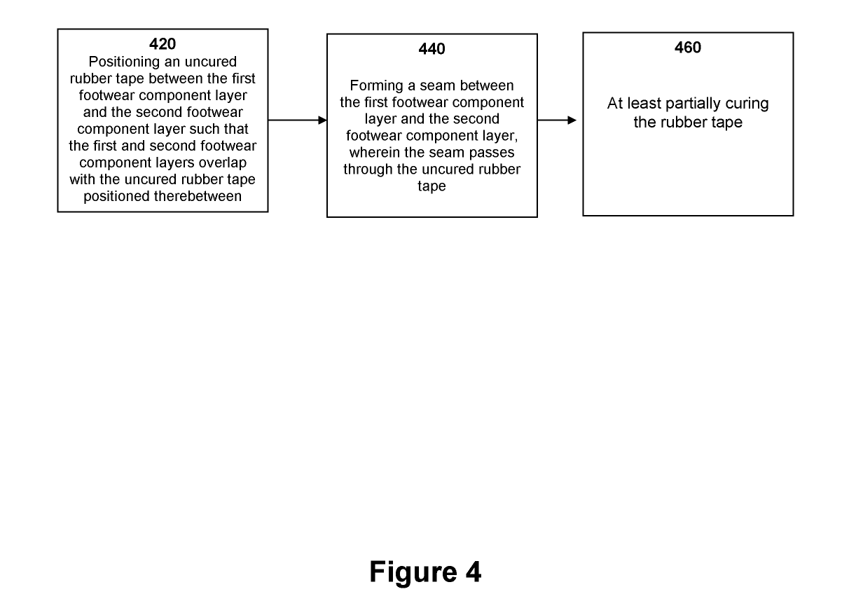

FIG. 4 is a schematic diagram illustrating a method of forming a waterproof seam in an article of footwear, in accordance with various embodiments:

(420) positioning an uncured rubber tape between a first footwear component layer and a second footwear component layer such that the first and second footwear component layers overlap with the uncured rubber tape positioned therebetween;

(440) forming a seam between the first footwear component layer and the second footwear component layer, wherein the seam passes through the uncured rubber tape; and

(460) at least partially curing the rubber tape.

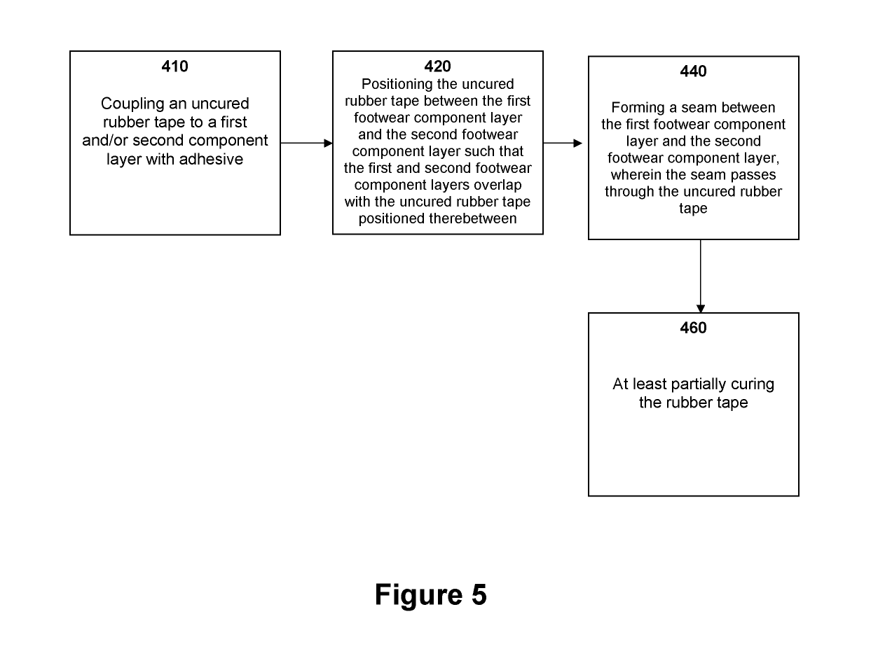

FIG. 5 is a schematic diagram illustrating a method of forming a waterproof seam in an article of footwear, in accordance with various embodiments. The steps include the features of FIG. 4, plus one additional step:

(410) coupling an uncured rubber tape to a first and/or second footwear component layer with adhesive;

(420) positioning the uncured rubber tape between the first footwear component layer and the second footwear component layer such that the first and second footwear component layers overlap with the uncured rubber tape positioned therebetween;

(440) forming a seam between the first footwear component layer and the second footwear component layer, wherein the seam passes through the uncured rubber tape; and

(460) at least partially curing the rubber tape.

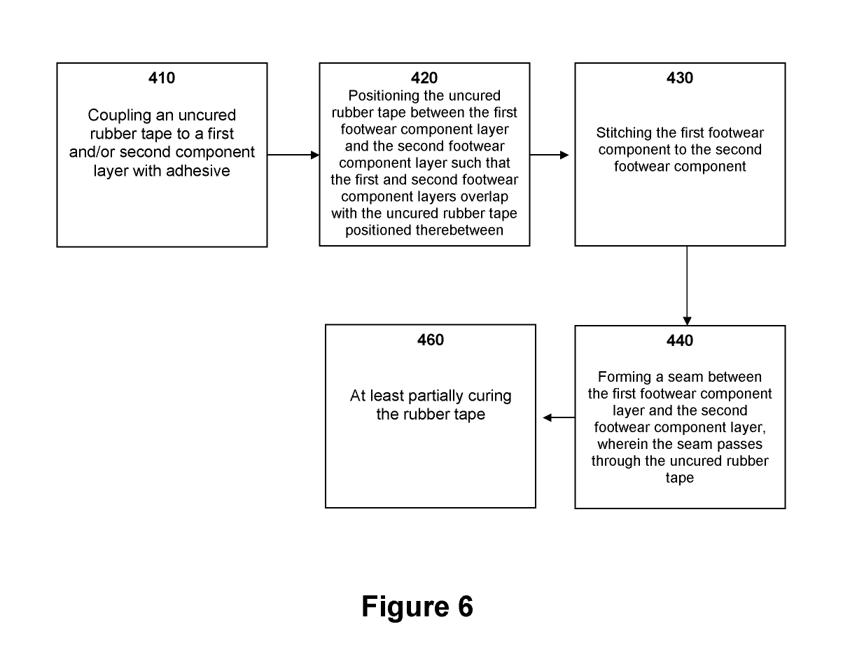

FIG. 6 is a schematic diagram illustrating a method of forming a waterproof seam in an article of footwear, in accordance with various embodiments. The steps include the features of FIG. 5, plus one additional step:

(410) coupling an uncured rubber tape to a first and/or second footwear component layer with adhesive;

(420) positioning the uncured rubber tape between the first footwear component layer and the second footwear component layer such that the first and second footwear component layers overlap with the uncured rubber tape positioned therebetween;

(430) stitching the first footwear component to the second footwear component;

(440) forming a seam between the first footwear component layer and the second footwear component layer, wherein the seam passes through the uncured rubber tape; and

(460) at least partially curing the rubber tape.

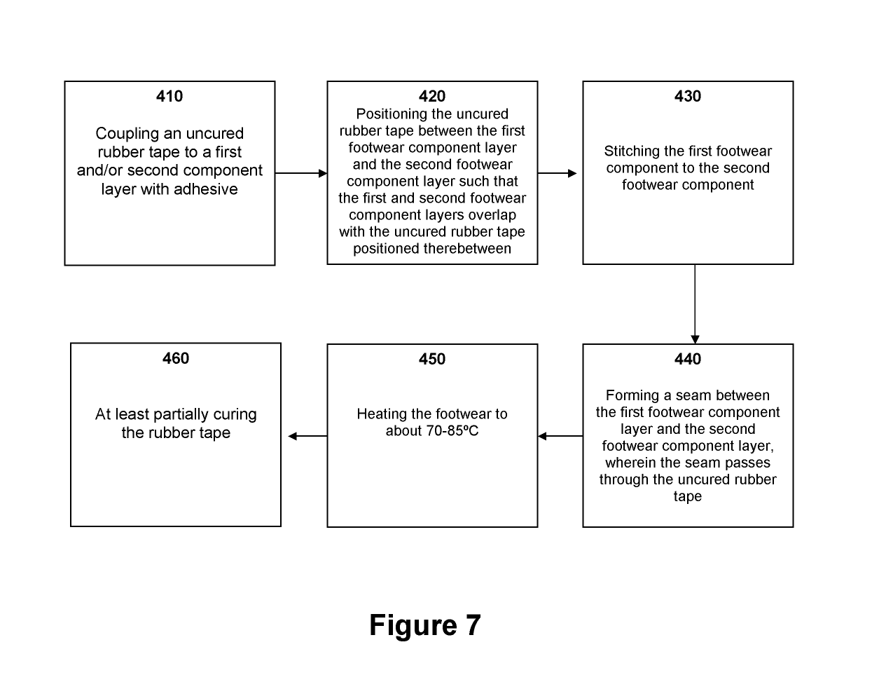

FIG. 7 is a schematic diagram illustrating a method of forming a waterproof seam in an article of footwear, in accordance with various embodiments. The steps include the features of FIG. 6, plus one additional step:

(410) coupling an uncured rubber tape to a first and/or second footwear component layer with adhesive;

(420) positioning the uncured rubber tape between the first footwear component layer and the second footwear component layer such that the first and second footwear component layers overlap with the uncured rubber tape positioned therebetween;

(430) stitching the first footwear component to the second footwear component;

(440) forming a seam between the first footwear component layer and the second footwear component layer, wherein the seam passes through the uncured rubber tape;

(450) heating the footwear to about 70-85° C.; and

(460) at least partially curing the rubber tape.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A method of waterproofing a footwear seam comprising:
positioning an uncured rubber tape between a first footwear component layer and a second footwear component layer such that the first and second footwear component layers overlap with the uncured rubber tape positioned therebetween;
forming a seam between the first footwear component layer and the second footwear component layer, wherein the seam passes through the uncured rubber tape; and
at least partially curing the rubber tape.

2. The method of claim 1, wherein the uncured rubber tape consists of a single layer.

3. The method of claim 1, wherein the uncured rubber tape comprises synthetic rubber, natural rubber, or a rubber composite.

4. The method of claim 1, wherein the uncured rubber tape comprises a polymer.

5. The method of claim 1, wherein forming the seam comprises stitching the seam.

6. The method of claim 1, wherein positioning the uncured rubber tape between the first footwear component layer and the second footwear component layer comprises coupling the uncured rubber tape to the first and/or second footwear component layer with adhesive.

7. The method of claim 1, wherein the first footwear component comprises an upper.

8. The method of claim 7, wherein the upper comprises leather.

9. The method of claim 1, wherein the second footwear component comprises a shell outsole.

10. The method of claim 1, wherein at least partially curing the rubber tape comprises heating the rubber tape.

11. The method of claim 10, wherein heating the rubber tape comprises heating the rubber tape to a temperature of about 50-100° C.

12. The method of claim 11, wherein heating the rubber tape comprises heating the rubber tape to a temperature of about 70-85° C. for about 5-10 minutes.

13. The method of claim 1, wherein the method further comprises applying one or more coats of gunking adhesive to the seam.

14. An article of footwear made by the method of claim 1.

15. A waterproof footwear seam comprising:
a first footwear component;
a second footwear component;
a layer of rubber tape positioned between the first footwear component and the second footwear component such that the first and second footwear components overlap with the layer of rubber tape positioned therebetween; and
at least one line of stitching passing through the first footwear component, the layer of rubber tape, and the second footwear component.

16. The waterproof footwear seam of claim 15, wherein the layer of rubber tape is substantially uncured.

17. The waterproof footwear seam of claim of claim 15, wherein the layer of rubber tape is at least partially cured.

18. The waterproof footwear seam of claim of claim 15, wherein the layer of rubber tape comprises synthetic rubber, natural rubber, or a rubber composite.

19. The waterproof footwear seam of claim of claim 15, wherein the layer rubber tape comprises a polymer.

20. The waterproof footwear seam of claim of claim 15, wherein the first component comprises an upper and the second component comprises a shell outsole.
